(19) United States
(12) Patent Application Publication
(10) Pub. No.: US 2023/0183509 A1
(43) Pub. Date: Jun. 15, 2023

(54) AQUEOUS INK, INK CARTRIDGE AND INK JET RECORDING METHOD

(71) Applicant: CANON KABUSHIKI KAISHA, Tokyo (JP)

(72) Inventors: MUTSUKI KUSADA, Chiba (JP); HIROSHI KAKIKAWA, Kanagawa (JP)

(21) Appl. No.: 18/078,379

(22) Filed: Dec. 9, 2022

(30) Foreign Application Priority Data
Dec. 15, 2021 (JP) 2021-203244
Nov. 21, 2022 (JP) 2022-185534

(51) Int. Cl. C09D 11/38; C09D 11/033; C09D 11/107; C09D 11/102; B41J 2/175

(52) U.S. Cl. CPC C09D 11/38; C09D 11/033; C09D 11/107; C09D 11/102; B41J 2/17503

(57) ABSTRACT

Provided is an aqueous ink containing: a pigment; a compound (A) represented by following general formula (1); and a compound (B) represented by following general formula (2). The weight average molecular weight of the compound (A) is 1,500 or more to 7,500 or less. The ratio of a content A (% by mass) of the compound (A) based on the total mass of the aqueous ink to the sum of the content A (% by mass) of the compound (A) and the content B (% by mass) of the compound (B) based on the total mass of the aqueous ink is 0.40 or less. The sum of the content A (% by mass) of the compound (A) and the content B (% by mass) of the compound (B) based on the total mass of the aqueous ink is 1.00% by mass or less.

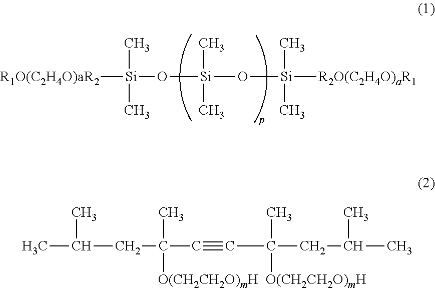

### BACKGROUND OF THE INVENTION

### Field of the Invention

The present invention relates to an aqueous ink, an ink cartridge and an ink jet recording method.

### Description of the Related Art

In recent years, ink jet recording methods have been used not only for home or office document printing but also for commercial and industrial printing and the like. In particular, wide-format ink jet recording apparatuses suitable for printing posters and wide-format advertisements have become popular. Such recording apparatuses are required to achieve higher recording speeds to improve throughput, and also to enhance the image quality of images they record. Various ink jet recording apparatuses have been developed to meet these requirements.

Recording apparatuses with higher recording speeds have reduced the time taken for a recording medium to be discharged onto the ink jet recording apparatus' loading tray or into its sheet discharge basket and stacked on another recording medium. For this reason, recording media get rubbed against each other immediately after recording, making the images thereon easily get scratched. Thus, the abrasion resistance is often problematic.

Also, poster and advertisement printing requires a wide color gamut and high color developability. As means for recording such images, a method is sometimes employed in which the amounts of inks to be applied are increased to increase the amounts of coloring materials on the recording medium. This method improves the color gamut and the color developability of obtained images, but entails a problem that a solid portion appears uneven. This is a phenomenon called “beading” in which ink dots having failed to be absorbed by the recording medium become locally integrated with each other and unevenly fixed. “Beading” tends to occur when the recording medium's ink absorbency is low.

Various proposals have been made to solve the above problems. For example, there have been proposals to improve the abrasion resistance of images by including a specific resin and a specific polyether-modified organosiloxane in an ink (Japanese Patent Application Laid-Open Nos. 2008-214611, 2003-192964, 2016-138259 and 2018-070730). Also, an ink containing a glycol ether compound, a silicone-based surfactant and a fluorine-based surfactant, and an ink containing a plurality of kinds of surfactants have been proposed as means for suppressing beading (Japanese Patent Application Laid-Open Nos. 2018-070730 and 2016-190981).

The present inventors recorded images with the inks proposed in Japanese Patent Application Laid-Open Nos. 2008-214611 and 2016-138259, and observed certain advantageous effects on abrasion resistance. However, the present inventors found that the high-molecular-weight silicone oil and resin clogged pores in the recording medium and lowered its ink permeability, thereby making it difficult to satisfy both abrasion resistance and beading resistance.

Also, when the present inventors recorded an image with the ink containing a silicone-based surfactant proposed in Japanese Patent Application Laid-Open No. 2003-192964, the abrasion resistance of the image was insufficient at regions where the recording duty was low. This is presumably due to the silicone-based surfactant added as a slip agent permeating the recording medium in its thickness direction along with an aqueous medium, thereby reducing the amount of the silicone-based surfactant remaining in the pigment layer formed by the ink. Also, the silicone-based surfactant lowered the surface energy of ink dots present in the form of a liquid on the recording medium. As a result, the ink applied later was repelled, causing density unevenness in the recorded image.

Japanese Patent Application Laid-Open No. 2018-070730 proposes an ink containing a silicone-based surfactant to reduce the tack of an ink layer to thereby provide abrasion resistance, and containing a fluorine-based surfactant to enhance the ink's permeation to thereby improve the beading resistance. However, when the present inventors recorded an image with the ink proposed in Japanese Patent Application Laid-Open No. 2018-070730, the silicone-based surfactant did not remain in pigment layers at regions where the recording duty was low, and the abrasion resistance of the image was therefore insufficient.

Also, in the method described in Japanese Patent Application Laid-Open No. 2018-070730, a recorded image is dried at a temperature of 100° C. to promote gelation of the ink so that good beading resistance can be obtained. However, when the present inventors dried an image at room temperature, the beading resistance dropped. This is presumably due to the use of large amounts of the silicone-based surfactant and fluorine-based surfactant, which have high abilities to lower surface tension, to enhance the ink's permeation. Furthermore, with the ink proposed in Japanese Patent Application Laid-Open No. 2016-190981, which contained a plurality of kinds of silicone-based surfactants differing in hydrophilic-lipophilic balance (HLB), the silicone-based surfactants reduced the surface energy of dots, so that density unevenness was observed in the image and the beading resistance was insufficient.

An object of the present invention is hence to provide an aqueous ink with which an image having excellent abrasion resistance and beading resistance can be recorded. Also, another object of the present invention is to provide an ink cartridge and an ink jet recording method using this aqueous ink.

### SUMMARY OF THE INVENTION

Specifically, the present invention provides an aqueous ink containing a pigment, a compound (A) represented by the following general formula (1) and a compound (B) represented by the general formula (2) below, a weight average molecular weight of the compound (A) is 1,500 or more to 7,500 or less, a ratio of a content A (% by mass) of the compound (A) based on a total mass of the aqueous ink to a sum of the content A (% by mass) of the compound (A) and a content B (% by mass) of the compound (B) based on the total mass of the aqueous ink is 0.40 or less, and the sum of the content A (% by mass) of the compound (A) and the content B (% by mass) of the compound (B) based on the total mass of the aqueous ink is 1.00% by mass or less;

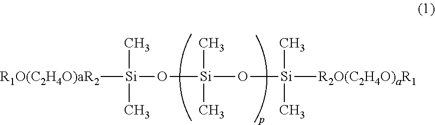

where R₁ represents a hydrogen atom or an alkyl group having 1 or more to 20 or less carbon atoms, R₂ represents an alkylene group having 1 or more to 20 or less carbon atoms, a represents an integer of 1 or more to 170 or less, and p represents an integer of 1 or more to 120 or less,

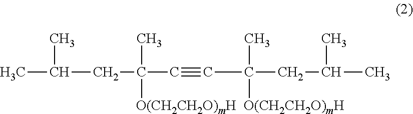

where m and n each independently represent an integer of 0 or more to 15 or less.

Further features of the present invention will become apparent from the following description of exemplary embodiments with reference to the attached drawings.

### BRIEF DESCRIPTION OF THE DRAWINGS

FIG. 1 is a cross-sectional view schematically illustrating one embodiment of an ink cartridge of the present invention.

FIGS. 2A and 2B are views schematically illustrating one example of an ink jet recording apparatus for use in an ink jet recording method of the present invention, FIG. 2A being a perspective view of a main part of the ink jet recording apparatus, FIG. 2B being a perspective view of a head cartridge.

### DESCRIPTION OF THE EMBODIMENTS

The present invention will further be described below in detail through preferred embodiments. In the present invention, when a compound is a salt, the salt is dissociated into ions in ink, and this state will be expressed as “containing a salt” for convenience. Moreover, an aqueous ink for ink jet will also be referred to simply as “ink”. Physical property values are values at normal temperature (25° C.) unless otherwise noted.

The present inventors firstly made studies on the composition of an aqueous ink for ink jet with which an image having excellent abrasion resistance could be recorded. To improve the abrasion resistance of an image, it is preferable to lower the surface energy of the pigment layer to render the pigment layer to facilitate slippery. Thus, the present inventors decided to include a silicone-based surfactant in the ink as a material for lowering the surface energy of a pigment layer.

A silicone-based surfactant is a surfactant obtained by introducing hydrophilic substituents to a polyorganosiloxane having siloxane bonds (SiO), which are silicon (Si) and oxygen atom (O) linked to one another alternately, as its main skeleton. The siloxane skeleton has a helical structure that makes a 360° twist with six SiO bonds. The siloxane bonds, having high hydrophilicity, are oriented inside the helix while organic groups having high hydrophobicity are oriented outside the helix. This characteristic structure allows the organic groups, which exert a small intermolecular interaction, to be located on the outside of a molecule. Thus, a low surface energy is exhibited. The present inventors considered that a silicone-based surfactant having such a structure can be expected to function as a slip agent.

However, images recorded using an ink containing a silicone-based surfactant did not exhibit satisfactory abrasion resistance. Specifically, low recording duty regions were vulnerable to scratches immediately after the recording, and thus was not abrasion resistance.

At low recording duty regions, the amount of the ink applied per unit area is so small that the aqueous medium in the ink permeates the recording medium in a short period of time. The silicone-based surfactant, which gets oriented on a gas-liquid interface relatively slowly, permeates a recording medium in its thickness direction along with the aqueous medium without getting sufficiently oriented at the gas-liquid interface. Accordingly, there is not enough amount of the surfactant remaining in the pigment layer. This can be considered why an abrasion resistance improving effect could not be achieved.

Next, the present inventors considered increasing the amount of the silicone-based surfactant to be present in the pigment layer. Specifically, they increased the amount of the silicone-based surfactant to be contained in the ink. This slightly improved the abrasion resistance of an image but not to a sufficient extent. Moreover, density unevenness was observed in the recorded image, and beading was found.

Increasing the amount of the silicone-based surfactant in the ink slightly improved the abrasion resistance of the image presumably because doing so increased the amount of the silicone-based surfactant remaining in the pigment layer, which in turn lowered the surface energy and rendered the pigment layer slippery. Note that lowering the surface energy of a pigment layer renders the pigment layer slippery but also lowers the wettability of the dot surfaces. Ink droplets applied over the dot surfaces given the reduced wettability due to the silicone-based surfactant do not mix but are repelled and unevenly fixed on the recording medium. This can be considered a cause of the density unevenness.

The above has led to a finding that it is difficult to satisfy both the abrasion resistance and beading resistance of an image by simply including a surface energy lowering component in an ink and adjusting the content of the component.

The present inventors further conducted studies on the composition of an aqueous ink for ink jet with which an image satisfying both abrasion resistance and beading resistance at high levels could be obtained. The present inventors then found that it was essential for an aqueous ink to meet the following conditions [1] to [5] in order for both properties to be satisfactory.

[1] The aqueous ink contains a compound (A) represented by General Formula (1) described above.

[2] The aqueous ink contains a compound (B) represented by General Formula (2) described above.

[3] The weight average molecular weight of the compound (A) is 1,500 or more to 7,500 or less.

[4] The ratio of a content A (% by mass) of the compound (A) based on the total mass of the aqueous ink to the sum of the content A (% by mass) of the compound (A) and a content B (% by mass) of the compound (B) based on the total mass of the aqueous ink is 0.40 or less.

[5] The sum of the content A (% by mass) of the compound (A) and the content B (% by mass) of the compound (B) based on the total mass of the aqueous ink is 1.00% by mass or less.

The present inventors have made the following presumption on a mechanism that can satisfy both abrasion resistance and beading resistance with the above configurations.

First of all, the ink of the present invention contains the compound (A) represented by General Formula (1) mentioned above, which is a silicone-based surfactant, and also the compound (B) represented by General Formula (2) mentioned above, which is an acetylene glycol-based surfactant. When an image is recorded using the ink containing these two kinds of surfactants, the two surfactants get competitively oriented at the gas-liquid interface of each dot ejected from the recording head and attached to the recording medium. The speed of orientation of the compound (B), which is an acetylene glycol-based surfactant, at the gas-liquid interface is faster than that of the compound (A), which is a silicone-based surfactant. For this reason, the compound (B), which is an acetylene glycol-based surfactant, is assumed to be oriented in a larger amount at the interface until a short period of time elapses after the application of the ink onto the recording medium. At this time, the molecules of the compound (B) oriented at the gas-liquid interface form a loose associated matter with a hydrophobic interaction.

On the other hand, the orientation speed of the compound (A), which is a silicone-based surfactant, is slow. When the silicone-based surfactant was contained alone in the ink, the silicone-based surfactant permeated the recording medium before being oriented due to its low orientation speed, as described earlier. Thus, the image could not be abrasion resistance. However, when the compound (B), which was an acetylene glycol-based surfactant, was additionally contained, the permeation of the compound (A), which was a silicone-based surfactant, into the recording medium was suppressed, and the compound (A) remained in a large amount in the pigment layer. This was presumably because the hydrophobic moieties of the compound (A), which was a silicone-based surfactant, interacted with the hydrophobic moieties of the associated matter of the compound (B), which was an acetylene glycol-based surfactant, oriented at the gas-liquid interface before the compound (A), thereby facilitating the orientation at the interface.

The compound (B), which is an acetylene glycol-based surfactant, has branched hydrophobic groups. Presumably, this bulky structure functioned as a steric barrier to delay the timing of the orientation of the compound (A), which was a silicone-based surfactant, at the surfaces of ink droplets and thus improved the beading resistance.

When the ink is applied to a recording medium, the compound (B), which is an acetylene glycol-based surfactant, firstly gets oriented at the surface of each ink droplet. This steric barrier delays the orientation of the compound (A), which is a silicone-based surfactant. Accordingly, the surface energy of the dot does not easily decrease immediately after the dot is formed. Another ink droplet applied over this dot therefore tends not to be repelled, and is fixed in a mixed state to the recording medium. This presumably solved the density unevenness.

The compound (A), which is a silicone-based surfactant with a slow orientation speed, gradually moves to the dot surface with time, thereby lowering the surface energy. This is considered to have improved the slipperiness of the formed pigment layer and rendered the image abrasion resistance.

As described above, the compound (B), which is an acetylene glycol-based surfactant, suppresses the permeation of the compound (A), which is a silicone-based surfactant, into a recording medium and enables the compound (A) to effectively remain in a pigment layer, and thus improves the abrasion resistance. Moreover, the compound (B), serving as a steric barrier, delays the orientation of the compound (A), making it possible to satisfy both abrasion resistance and beading resistance.

However, there were cases where the advantageous effects of the present invention could not be achieved by simply including these surfactants in the ink. The interaction between the two surfactants functions so as to achieve the advantageous effects of the present invention only when the conditions [1] and [3] to [5] are satisfied in addition to the above. Details of this will be discussed below.

First of all, to obtain an image with the high level of abrasion resistance which the present invention is intended to achieve, it is necessary to use the compound (A) represented by General Formula (1), i.e., a silicone-based surfactant with both terminals modified with ethylene oxide groups. As mentioned earlier, the siloxane skeleton has a helical structure that makes a 360° twist with six SiO bonds. The SiO bonds, which are hydrophilic, are oriented inside the helix while hydrophobic organic groups are oriented outside the helix. The low surface energy of the silicone compound originates from the characteristic molecular structure covered with methyl groups, which have a low intermolecular force. The compound (A) represented by General Formula (1) has ethylene oxide groups introduced at both terminals of the molecule, and the moiety other than the terminals is covered with methyl groups. Thus, a surface energy lowering effect is considered to be efficiently achieved by the continuous series of methyl groups.

The silicone-based surfactant includes one with a side chain modified with an ethylene oxide group(s) like the compound represented by following General Formula (3), in addition to the structure represented by General Formula (1). The silicone-based surfactant also includes one with a block structure(s) of a polydimethylsiloxane structure and an ethylene oxide structure(s) like the compound represented by General Formula (4). In the silicone-based surfactants with these structures, some of the methyl groups covering the outside of the siloxane skeleton are modified with ethylene oxide groups, which are hydrophilic, making the series of methyl groups less continuous. The surface energy lowering effect is therefore considered to be insufficient.

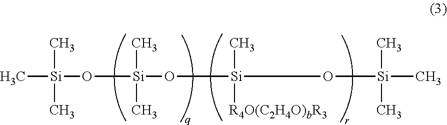

(where R₃ represents a hydrogen atom or an alkyl group, R₄ represents an alkylene group, and b, q and r represent integers.)

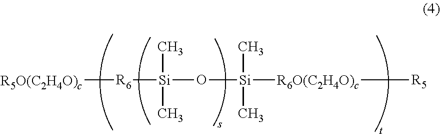

(where R₅ represents a hydrogen atom or an alkyl group, R₆ represents an alkylene group, and c, s, and t represent integers.)

Furthermore, the compound (A) represented by General Formula (1), which is a silicone-based surfactant, is the most suitable structure for interaction with the compound (B) represented by General Formula (2), which is an acetylene glycol-based surfactant, also from the viewpoint of enhancing the beading resistance.

The compound (A) represented by General Formula (1) has hydrophilic groups introduced at both terminals of the molecule, and hydrophobic moieties are present at positions associated together within the molecule. Thus, the hydrophobic interaction exerted between molecules is considered to be relatively great. On the other hand, the compounds represented by General Formulas (3) and (4) have structures in which a hydrophilic moiety is sandwiched between hydrophobic moieties. Thus, the hydrophobic interaction exerted between molecules is considered to be small. The compound (A) represented by General Formula (1) undergoes a greater intermolecular interaction and is therefore more apt to form a large associated matter. Hence, by being sterically hindered by the compound (B) represented by General Formula (2), which is an acetylene glycol-based surfactant, the compound (A) can spend time to be oriented at a gas-liquid interface. This presumably enables excellent beading resistance.

Moreover, the weight average molecular weight (Mw) of the compound (A) represented by General Formula (1), which is a silicone-based surfactant, needs to be 1,500 or more to 7,500 or less. If the weight average molecular weight of the compound (A) is less than 1,500, the number of repetitions of methyl groups, which lower the surface energy and enables slippage, is so small that abrasion resistance cannot be obtained. Specifically, if the weight average molecular weight of the compound (A) is less than 1,500, the number of repetitions of methyl groups is so small that abrasion resistance cannot be obtained regardless of what value and substituents are used for a, R₁ and R₂ in General Formula (1).

If the weight average molecular weight of the compound (A), which is a silicone-based surfactant, is more than 7,500, beading resistance cannot be obtained. For example, when a commercially-available silicone-based surfactant with a trade name “BYK-333” (weight average molecular weight: 8,000, manufactured by BYK-Chemie GmbH) was used, beading resistance was not obtained. Many kinds of compounds (A), which are silicone-based surfactants, are such that their orientation at a dot surface can be delayed by the steric barrier of the compound (B), which is an acetylene glycol-based surfactant. However, due to the instability of association of the compound (B), some compounds (A) can pass the steric barrier and be oriented at a dot surface. A compound (A) with a weight average molecular weight of more than 7,500 has a high ability to lower surface energy and therefore exerts a strong force to repel ink droplets when oriented at a dot surface since the number of repetitions of methyl groups is large. This lowers the beading resistance.

The ratio of the content A (% by mass) of the compound (A), which is a silicone-based surfactant, based on the total mass of the ink to the sum of the content A (% by mass) of the compound (A) and the content B (% by mass) of the compound (B), which is an acetylene glycol-based surfactant, based on the total mass of the ink is 0.40 or less. In short, the ratio satisfies Formula (5) below.

A/(A+B)≤0.40 (5)

The value of A/(A+B) in Formula (5) represents the ratio of the content of the silicone-based surfactant (compound (A)) to the total content of the silicone-based surfactant (compound (A)) and the acetylene glycol-based surfactant (compound (B)) in the ink. If this ratio is more than 0.40, the ratio of the compound (A) is so high and the ratio of the compound (B) is so low that the sterically hindering effect by the compound (B) will be insufficient. This will render ink droplets apt to repel each other and lower the beading resistance.

Moreover, the sum of the content A (% by mass) of the compound (A), which is a silicone-based surfactant, and the content B (% by mass) of the compound (B), which is an acetylene glycol-based surfactant, based on the total mass of the aqueous ink is 1.00% by mass or less. If the sum of the contents is more than 1.00% by mass, the total amount of the compound (A) contained in the ink is so large as to render the ink apt to be repelled at dot surfaces and thus lower the beading resistance even if the amount ratio of the compounds (A) and (B) satisfies Formula (5).

<Ink>

Hereinbelow, constituent components of the ink of the present invention, physical properties of the ink and so on will be described in detail.

(Compound (A) Represented by General Formula (1))

The ink contains a compound (A) represented by following General Formula (1), which is a nonionic silicone-based surfactant. The ink can contain one or two or more kinds of compounds (A) represented by General Formula (1). Herein, the compound(s) (A) represented by General Formula (1) will also be referred to simply as “compound (A)”. The compound (A) can be synthesized as a mixture of those with various molecular weights due to their difference in degree of polysiloxane polymerization (p) and, for convenience, will be denoted as “compound” including such mixtures. Also, since the compound (A) can be synthesized as a mixture, a and p can be considered mass-weighted average values. In this case, a and p can be decimals but will be handled herein as integers obtained by rounding off the digit(s) after the decimal point. Note that the C₂H₄O in the compound (A) represented by General Formula (1) represents an ethylene oxide unit.

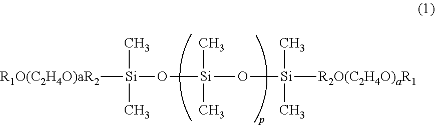

(where R₁ represents a hydrogen atom or an alkyl group having 1 or more to 20 or less carbon atoms, R₂ represents an alkylene group having 1 or more to 20 or less carbon atoms, a represents an integer of 1 or more to 170 or less, and p represents an integer of 1 or more to 120 or less)

R₁ in General Formula (1) is preferably a hydrogen atom or an alkyl group having 1 or more to 10 or less carbon atoms, more preferably a hydrogen atom, a methyl group, an ethyl group or a propyl group, and further preferably a hydrogen atom. R₂ in General Formula (1) is preferably an alkylene group having 1 or more to 10 or less carbon atoms, more preferably an ethylene group, a propylene group or a butylene group, and further preferably a propylene group. Also, a in General Formula (1) is preferably an integer of 1 or more to 100 or less and more preferably an integer of 1 or more to 50 or less. Moreover, p in General Formula (1) is preferably an integer of 1 or more to 100 or less and more preferably an integer of 1 or more to 50 or less.

In the compound (A) represented by General Formula (1), the ratio of the number of moles of ethylene oxide added in the compound (A) to the degree of polysiloxane polymerization (degree of polydimethylsiloxane polymerization) in the compound (A) is preferably 1.0 or more to 10.0 or less. Specifically, in the compound (A), the ratio (2a/p) of the total (2a) of the number of moles of ethylene oxide added represented by a in General Formula (1) to the degree of polysiloxane polymerization (p) represented by p in General Formula (1) is preferably 1.0 or more to 10.0 or less. In short, the relation between the above-mentioned total (2a) of the number of moles of ethylene oxide added and the above-mentioned degree of polysiloxane polymerization (p) preferably satisfies Formula (6) below.

1.0≤2a/p≤10.0 (6)

(where a and p are the same as a and p in General Formula (1))

The number of moles of ethylene oxide added represented by 2a in Formula (6) serves as an index indicating the degree of hydrophilicity of the compound (A), which is a silicone-based surfactant. Also, the degree of polysiloxane polymerization represented by p serves as an index indicating the degree of hydrophobicity of the compound (A), which is a silicone-based surfactant. When the value of 2a/p is 1.0 or more, the hydrophilicity of the compound (A), which is a silicone-based surfactant, is adequately high. This makes it easier to enhance the beading resistance. On the other hand, when the value of 2a/p is 10.0 or less, the hydrophobicity of the compound (A), which is a silicone-based surfactant, is adequate. This makes it easier to enhance the abrasion resistance. The value of 2a/p is more preferably 2.0 or more to 5.0 or less.

The weight average molecular weight (Mw) of the compound (A) represented by General Formula (1), which is a silicone-based surfactant, needs to be 1,500 or more to 7,500 or less and particularly preferably 2,000 or more to 5,000 or less. The weight average molecular weight (Mw) is a weight average molecular weight in terms of polystyrene in a molecular weight distribution measured by gel permeation chromatography (GPC). The compound (A), which is a silicone-based surfactant, is a mixture of substances with various molecular weights. Thus, the molecular weight of the compound (A) is derived as a weight-weighted average molecular weight.

As described above, the weight average molecular weight (Mw) of the compound (A) represented by General Formula (1), which is a silicone-based surfactant, can be measured by gel permeation chromatography (GPC) using tetrahydrofuran (THF) as the mobile phase. Details of the method of measuring Mw of the compound (A) are as follows. Incidentally, Mw of Compounds used in Examples to be described later was measured by the preferable measurement method discussed below. Measurement conditions such as the filter, column, standard polystyrene samples, their molecular weights and so on are not limited to those listed below.

First of all, a measurement target sample is charged in tetrahydrofuran (THF) and left to stand for several hours to dissolve. As a result, a solution is prepared. Thereafter, the solution is filtered through a solvent-resistant membrane filter with a pore size of 0.2 μm to obtain a sample solution. The density of the sample in the sample solution is adjusted such that the content of the compound (A) will be 0.1% by mass to 0.3% by mass. A refractive index detector is used for the GPC. Also, in order to perform accurate measurement in a molecular weight range of 10³ to 2×10⁶, it is preferable to combine a plurality of commercially available polystyrene gel columns. For example, it is possible to use a combination of four of Shodex LF-804 (manufactured by Showa Denko K.K.) or to use columns comparable to these. THF as a mobile phase is caused to flow at a flow speed of 1 mL/min through the column stabilized within a heat chamber at 40.0° C., and approximately 0.1 mL of the above sample solution is introduced. The weight average molecular weight of the sample is determined using a molecular weight calibration curve created with standard polystyrene samples. As the standard polystyrene samples, ones with a molecular weight of about 10² to 10⁷ (e.g., ones manufactured by Polymer Laboratories Ltd.) are used. It is appropriate to use at least about 10 kinds of standard polystyrene samples.

(Compound (B) Represented by General Formula (2))

The ink contains a compound (B) represented by General Formula (2), which is an acetylene glycol-based surfactant, as well as the compound (A) represented by General Formula (1). The compound (B) represented by General Formula (2) is a nonionic surfactant. The ink can contain one or two or more kinds of compounds (B) represented by General Formula (2).

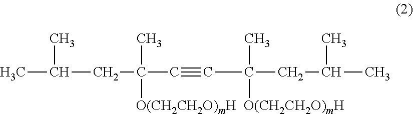

(where m and n each independently represent an integer of 0 or more to 15 or less)

When m and n in general formula (2) are 0, they represent a single bond. In this case, the compound represented by general formula (2) means that the hydroxy group is bonded to the carbon atom that bonds to the acetylene group in general formula (2).

(Contents of Surfactants)

The content A (% by mass) of the compound (A) represented by General Formula (1) in the ink is preferably 0.05% by mass or more to 0.80% or less and more preferably 0.10% by mass or more to 0.50% or less based on the total mass of the ink. Setting the content A of the compound (A) at 0.10% by mass or more makes it easier for the compound (A) to remain in a pigment layer and obtain an image having excellent abrasion resistance. Also, setting the content A of the compound (A) at 0.50% by mass or less makes it easier to obtain an image having more excellent beading resistance.

The content B (% by mass) of the compound (B) represented by General Formula (2), which is an acetylene glycol-based surfactant, is preferably 0.10% by mass or more to 0.80% or less based on the total mass of the ink from the viewpoint of satisfying both abrasion resistance and beading resistance. The content B (% by mass) of the compound (B) is more preferably 0.20% by mass or more to 0.50% or less.

The ratio of the content A (% by mass) of the compound (A) based on the total mass of the ink to the sum of the content A (% by mass) of the compound (A) and the content B (% by mass) of the compound (B) based on the total mass of the ink is 0.40 or less. In short, the relation between the content A (% by mass) of the compound (A) represented by General Formula (1) and the content B (% by mass) of the compound (B) represented by General Formula (2) satisfies Formula (5) below.

A/(A+B)≤0.40 (5)

If A/(A+B) is more than 0.40, the amount of the compound (A) represented by General Formula (1), which is a silicone-based surfactant, is so large that ink droplets will tend to repel each other. This will lower the beading resistance. A/(A+B) is preferably 0.20 or more, more preferably 0.30 or more, and preferably 0.35 or less.

Moreover, the sum (% by mass) of the content A (% by mass) of the compound (A) represented by General Formula (1) and the content B (% by mass) of the compound (B) represented by General Formula (2) based on the total mass of the ink is 1.00% by mass or less. If the sum of the content A of the compound (A) and the content B of the compound (B) is more than 1.00% by mass, then, even when the ratio in amount of the compounds (A) and (B) satisfies Formula (5), the total amount of the compound (A) in the ink is so large that dot surfaces tend to be slippery. This lowers the beading resistance. The sum of the content A of the compound (A) and the content B of the compound (B) is preferably 0.10% by mass or more and more preferably 0.20% by mass or more, and preferably 0.80% by mass or less.

(HLB Values of Surfactants)

One physical property value indicating the degree of hydrophilicity or lipophilicity of a nonionic surfactant is an HLB value derived by Griffin method, which takes a value of 0 or more to 20 or less. The smaller the HLB value, the higher the lipophilicity. The larger the HLB value, the higher the hydrophilicity. The HLB value by Griffin method can be calculated by Formula (7) below. For the above-described compound (A) represented by General Formula (1), which is a silicone-based surfactant, and the above-described compound (B) represented by General Formula (2), which is an acetylene glycol-based surfactant, “Hydrophilic Moieties” in Formula (7) below are ethylene oxide groups.

HLB Value=20×Sum of Formula Weights of Hydrophilic Moieties of Surfactant/Molecular Weight of Surfactant (7)

In one embodiment of the present invention, the absolute value of the difference between the HLB value of the compound (A) represented by General Formula (1), which is a silicone-based surfactant, and the HLB value of the compound (B) represented by General Formula (2), which is an acetylene glycol-based surfactant, is preferably 10 or less. Setting this absolute value of the difference in HLB value at 10 or less, i.e., 0 or more to 10 or less enhances the compatibility between the compounds (A) and (B). In this way, the compound (A), which is a silicone-based surfactant, easily mixes with the compound (B), which is an acetylene glycol-based surfactant and gets oriented at a gas-liquid interface first, and the compound (A) is more likely to remain in the pigment layer. This makes it easier to obtain an image having more excellent abrasion resistance. The HLB value of the above compound (A) is a mass-weighted average of the HLB values of the two or more kinds of compounds (A) in the case where the ink contains the two or more kinds of compounds (A). Likewise, the HLB value of the above compound (B) is a mass-weighted average of the HLB values of the two or more kinds of compounds (B) in the case where the ink contains the two or more kinds of compounds (B).

The HLB value of the compound (A) represented by General Formula (1) is preferably 1 or more to 16 or less, more preferably 5 or more to 15 or less, and further preferably 8 or more to 15 or less. Also, the HLB value of the compound (B) represented by General Formula (2) is preferably 1 or more to 19 or less, more preferably 5 or more to 19 or less, and further preferably 9 or more to 15 or less. Setting the HLB value of each surfactant within the above range facilitates the interaction between the compound (A), which is a silicone-based surfactant, and the compound (B), which is an acetylene glycol-based surfactant. Accordingly, an advantageous effect is easily achieved on the abrasion resistance.

(Pigment)

The ink contains a pigment as a coloring material. The content (% by mass) of the pigment in the ink is preferably 0.10% by mass or more to 15.00% or less and more preferably 1.00% by mass or more to 10.00% or less based on the total mass of the ink from the viewpoint of satisfying both color developability and ejection stability.

Specific examples of the pigment include: inorganic pigments such as carbon black and titanium oxide; and organic pigments such as azo, phthalocyanine, quinacridone, isoindolinone, imidazolone, diketopyrrolopyrrole, dioxazine and perinone. Of these pigments, carbon black and the organic pigments are preferable. The ink can contain one or two or more kinds of pigments.

Usable pigments categorized by the form of dispersion include a resin-dispersed pigment using a resin as a dispersant, a self-dispersible pigment obtained by bonding a hydrophilic group to the particle surface of a pigment, and so on. The usable pigments also include a resin-bonded pigment obtained by chemically bonding an organic group containing a resin to the particle surface of a pigment, a microcapsule pigment obtained by covering the particle surface of a pigment with a resin or the like, and so on. Of these, it is preferable to use a resin-dispersed pigment obtained by physically adsorbing a resin as a dispersant to the particle surface of a pigment, instead of the resin-bonded pigment or microcapsule pigment.

As the resin dispersant for dispersing the pigment within an aqueous medium, it is preferable to use one that disperses the pigment within the aqueous medium by an action of an anionic group. A water-soluble resin can be used as the resin dispersant. The mass ratio of the content (% by mass) of the pigment in the ink to the content of the resin dispersant is preferably 0.3 or more to 10.0 or less.

As the self-dispersible pigment, it is possible to use one having an anionic group such as a carboxylic acid group, a sulfonic acid group or a phosphonic acid group bonded to the particle surface of a pigment either directly or via another group of atoms (—R—). The anionic group may be either an acid or salt type. When the anionic group is the salt type, it may be either partially dissociated or fully dissociated. Examples of cations as counterions in the case where the anionic group is the salt type include alkali metal cations, ammonium, organic ammonium and the like. Specific examples of the other group of atoms (—R—) include: a linear or branched alkylene group having 1 to 12 carbon atom; an arylene group such as a phenylene group or a naphthylene group; a carbonyl group; an imino group; an amide group; a sulfonyl group; an ester group; an ether group; and so on. A group combining these groups may be used.

(Resin)

The ink can contain one or two or more kinds of resins. The content (% by mass) of the resin in the ink is preferably 0.10% by mass or more to 20.00% or less and more preferably 0.50% by mass or more to 15.00% or less based on the total mass of the ink from the viewpoint of image clarity.

For the purpose of (i) stabilizing the dispersed state of the pigment, the resin can be added to the ink as a resin dispersant or as an aid for it. Also, the resin can be added to the ink for the purpose of (ii) improving various properties of images to be recorded. Examples of the form of the resin include a block copolymer, a random copolymer, a graft copolymer, combinations of these, and so on. The resin may be a water-soluble resin soluble in an aqueous medium or a resin particle dispersible in an aqueous medium. The resin particle does not need to encapsulate the coloring material.

Herein, a state where “a resin is water soluble” means that the resin can be present in an aqueous medium in a state of not being formed as a particle whose particle size can be measured by dynamic light scattering when neutralized with an alkali in an amount equivalent to the acid value of the resin.

Whether a resin is water soluble can be determined by following the method described below. First, a liquid containing the resin neutralized with an amount of an alkali (such as sodium hydroxide or potassium hydroxide) corresponding to the acid value (resin solid content: 10% by mass) is prepared. Next, the prepared liquid is diluted 10-fold (in terms of volume) with pure water to prepare a sample solution. If a particle having a particle size is not observed in measurement of the particle size of the resin in the sample solution by dynamic light scattering, the resin can be determined as “water soluble”. As a particle size distribution measurement apparatus using dynamic light scattering, a particle size analyzer (e.g., trade name “UPA-EX150”, manufactured by NIKKISO CO., LTD.) or the like can be used. The conditions for this measurement can be as follows, for example:

SetZero: 30 seconds

Number of times measurement is performed: 3

Measurement duration: 180 seconds

Needless to say, the particle size distribution measurement apparatus to be used, the measurement conditions and the like are not limited to the above.

Examples of the resin include an acrylic-based resin, a urethane-based resin, an olefin-based resin, a polyester-based resin and so on. Of these, the acrylic-based resin and the urethane-based resin are preferable. In the following description, the terms “(meth)acrylic acid” and “(meth)acrylate” represent “acrylic acid, methacrylic acid” and “acrylate, methacrylate”, respectively.

The acrylic-based resin is preferably one having a hydrophilic unit and a hydrophobic unit as its constituent units. Of such resins, one having a hydrophilic unit derived from a (meth)acrylic acid and a hydrophobic unit derived from at least one of a monomer having an aromatic ring or a (meth)acrylic acid ester-based monomer is preferable. Particularly preferable is a resin having a hydrophilic unit derived from a (meth)acrylic acid and a hydrophobic unit derived from a monomer of at least one of styrene or α-methylstyrene. These resins easily interact with the pigment, and are therefore preferably usable as resin dispersants for dispersing the pigment.

The hydrophilic unit is a unit having a hydrophilic group such as an anionic group. The hydrophilic unit can be formed by, for example, polymerizing a hydrophilic monomer having the hydrophilic group. Specific examples of the hydrophilic monomer having the hydrophilic group include: acidic monomers having a carboxylic acid group such as a (meth)acrylic acid, itaconic acid, maleic acid or fumaric acid; anionic monomers such as anhydrides and salts of these acidic monomers; and so on. Examples of the cations forming the salts of the acidic monomers include ions of lithium, sodium, potassium, ammonium, organic ammonium and so on.

The hydrophobic unit is a unit not having a hydrophilic group such as an anionic group. The hydrophobic unit can be formed by, for example, polymerizing a hydrophobic monomer not having a hydrophilic group such as anionic group. Specific examples of the hydrophobic monomer include: monomers having an aromatic ring such as styrene, α-methylstyrene and benzyl (meth)acrylate; (meth)acrylic acid ester-based monomers such as methyl (meth)acrylate, butyl (meth)acrylate and 2-ethylhexyl (meth)acrylate; and so on. The acid value of the acrylic-based resin is preferably 100 mgKOH/g or more to 250 mgKOH/g or less.

The urethane-based resin can be obtained by, for example, reacting a polyisocyanate and a polyol with each other. The urethane-based resin may also be one obtained by further reacting a chain extender. In the case of a water-soluble urethane resin, its acid value is preferably 45 mgKOH/g or more to 70 mgKOH/g or less from the viewpoint of the solubility in the ink. Examples of the olefin-based resin include polyethylene, polypropylene and so on. The polyester-based resin can be obtained by, for example, reacting a polyol and a polycarboxylic acid with each other.

(Aqueous Medium)

The ink is an aqueous ink containing at least water as an aqueous medium. The ink can contain a water-soluble organic solvent as an aqueous medium. As the water, deionized water or ion-exchanged water is preferably used. The content (% by mass) of the water in the ink is preferably 40.00% by mass or more to 95.00% or less based on the total mass of the ink. The content of the water is more preferably 50.00% by mass or more to 95.00% or less and further preferably 50.00% by mass or more to 90.00% or less.

Also, as the water-soluble organic solvent, any of those commonly used in inks can be used. Examples include alcohols, (poly)alkylene glycols, glycol ethers, nitrogen-containing compounds, sulfur-containing compounds and so on. The content (% by mass) of the water-soluble organic solvent in the ink is preferably 3.00% by mass or more to 50.00% or less based on the total mass of the ink. The content of the water-soluble organic solvent is more preferably 7.00% by mass or more to 45.00% or less and further preferably 10.00% by mass or more to 40.00% or less. The glycol ethers tend to excessively increase the permeation of the ink. Thus, in the case of using any of the glycol ethers, its content is preferably very low. Specifically, the content of any of the glycol ethers in the ink is preferably 0.10% by mass or less and more preferably 0.05% by mass or less based on the total mass of the ink.

(Additives)

Besides the components described above, the ink may contain a water-soluble organic compound that is solid at normal temperature including polyalcohols such as trimethylolpropane and trimethylolethane, urea and a urea derivative such as ethylene urea as appropriate. Further, the ink may contain various additives such as a surfactant other than those described above, pH adjuster, corrosion inhibitor, preservative, mildewproofing agent, antioxidant, reduction inhibitor, evaporation accelerator, chelator and other resins as appropriate. In the case of using a surfactant other than those described above, such as a fluorine-based surfactant or an ionic surfactant, its content is preferably very low. Specifically, in the ink, the content (% by mass) of the surfactant other than those described above is preferably 0.10% by mass or less and more preferably 0.05% by mass or less based on the total mass of the ink.

(Physical Properties of Ink)

The static surface tension of the ink is measured using a Wilhelmy-type surface tension meter (such as, e.g., trade name “Automatic Surface Tensiometer CBVP-Z”, manufactured by Kyowa Interface Science Co., Ltd.). Also, the dynamic surface tension of the ink is measured using a dynamic surface tension meter using a maximum bubble pressure method (such as, e.g., trade name “BUBBLE PRESSURE TENSIOMETER BP-100”, manufactured by KRÜSS GmbH). The maximum bubble pressure method is a method involving measuring the maximum pressure required to release bubbles produced in the tip of a probe (narrow tube) immersed in a measurement target liquid, and deriving the surface tension of the liquid from the measured maximum pressure. Specifically, the maximum pressure is measured while bubbles are produced continuously at the tip of the probe. The period of time from a point when a new bubble's surface is generated at the tip of the probe to a point when the maximum bubble pressure is reached (a point when the radius of curvature of the bubble and the radius of the tip portion of the probe become equal) will be referred to as “lifetime”. In other words, the maximum bubble pressure method is a method of measuring the surface tension of a liquid in a dynamic state.

A static surface tension γₛ of the ink at 25° C. is preferably 32.0 mN/m or less. Setting the static surface tension γₛ of the ink at 32.0 mN/m or less enhances the permeation of the ink into a recording medium. The ink is less likely to overflow on a recording medium, and thus makes it easier to enhance the beading resistance. The static surface tension γₛ of the ink at 25° C. is preferably 20.0 mN/m or more and more preferably 25.0 mN/m or more. Also, a dynamic surface tension γ₁₀ of the ink at 25° C. at a lifetime of 10 milliseconds is preferably 30.0 mN/m or more to 50.0 mN/m or less and more preferably 35.0 mN/m or more to 40.0 mN/m or less.

An absolute value |γ₁₀−γₛ| of the difference between the dynamic surface tension γ₁₀ of the ink at 25° C. at a lifetime of 10 milliseconds and the static surface tension γₛ is preferably 4.0 mN/m or more to 10.0 mN/m or less. Setting the absolute value |γ₁₀−γₛ| of the difference between the ink's dynamic surface tension γ₁₀ and static surface tension γₛ at 4.0 mN/m or more to 10.0 mN/m or less makes it easier to enhance the beading resistance. If |γ₁₀−γₛ| is more than 10.0 mN/m, the surface tension of the ink immediately after being applied to a recording medium is so high that it will take time for the ink to permeate the recording medium. Accordingly, the amount of the compound (A), which is a silicone-based surfactant, to be oriented at the surfaces of ink droplets will be large. If |γ₁₀−γₛ| is less than 4.0 mN/m, the decrease in the surface tension of the ink after being applied to a recording medium is so low that the permeation of the ink into the recording medium will not progress. Accordingly, the amount of the compound (A), which is a silicone-based surfactant, to be oriented at the surfaces of ink droplets will be large. As a result, when |γ₁₀−γₛ| is more than 10.0 mN/m or less than 4.0 mN/m, the amount of the compound (A), which is a silicone-based surfactant, to be present at the surfaces of dots formed will be large. This tends to lower the surface energy. Accordingly, ink droplets applied over these dots tend to be repelled, and the beading resistance may slightly decrease to a tolerable extent.

By setting the static surface tension γₛ of the ink and the absolute value |γ₁₀−γₛ| of the difference between the dynamic surface tension γ₁₀ at a lifetime of 10 milliseconds and the static surface tension γₛ within the above respective ranges, it is possible to obtain images with more excellent beading resistance regardless of the type of recording medium. Hence, the static surface tension γₛ of the ink is more preferably 25.0 mN/m or more to 32.0 mN/m or less, and the dynamic surface tension γ₁₀ at a lifetime of 10 milliseconds is preferably 30.0 mN/m or more to 50.0 mN/m or less. Moreover, the absolute value |γ₁₀−γₛ| of the difference between the dynamic surface tension γ₁₀ at a lifetime of 10 milliseconds and the static surface tension γₛ is preferably 5.0 mN/m or more to 9.0 mN/m or less.

It is preferable to appropriately control the values of the ink's physical properties in order for the ink to be used for an ink jet type. The pH of the ink at 25° C. is preferably 5.0 or more to 10.0 or less and more preferably 7.0 or more to 9.5 or less. The viscosity of the ink at 25° C. is preferably 1.0 mPa s or more to 5.0 mPa s or less.

<Ink Cartridge>

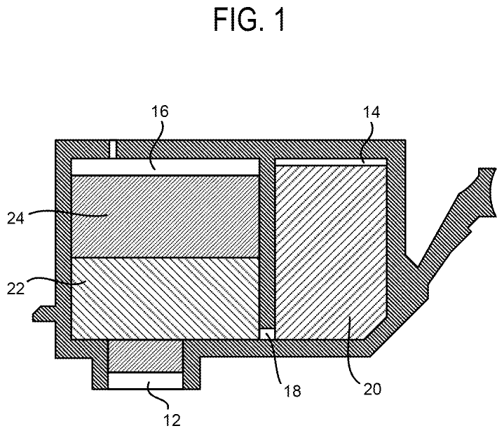

An ink cartridge of the present invention includes an ink and an ink storage portion that contains this ink. Moreover, the ink contained in this ink storage portion is the aqueous ink of the present invention described above. FIG. 1 is a cross-sectional view schematically illustrating one embodiment of the ink cartridge of the present invention. As illustrated in FIG. 1, at the bottom surface of the ink cartridge, there is provided an ink supply port 12 for supplying the ink to a recording head. The inside of the ink cartridge is an ink storage portion for storing the ink. The ink storage portion includes an ink storing chamber 14 and an absorber holding chamber 16, which communicate with each other through a communication port 18. The absorber holding chamber 16 also communicates with the ink supply port 12. The ink storing chamber 14 contains a liquid ink 20, and the absorber holding chamber 16 contains absorbers 22 and 24 that hold the ink in an immersed state. The configuration of the ink storage portion may be such that it has no ink storing chamber for storing the liquid ink and holds the entire amount of the ink to be contained by means of the absorbers. Alternatively, the configuration of the ink storage portion may be such that it has no absorber and contains the entire amount of the ink in the form of liquid. Still alternatively, an ink cartridge with a configuration in which it has an ink storage portion and a recording head may be employed.

<Ink Jet Recording Method>

The ink jet recording method of the present invention is a method of recording an image onto a recording medium by ejecting the aqueous ink of the present invention described above from a recording head of an ink jet type. Examples of the ink ejection method include a method involving applying mechanical energy to the ink and a method involving applying thermal energy to the ink. In the present invention, it is particularly preferable to employ the method involving applying thermal energy to the ink. Besides using the ink of the present invention, the steps in the ink jet recording method may be publicly known steps. In the present invention, the ink jet recording method only needs to include a step of applying the ink onto a recording medium, and does not have to include other processes (such as a step of applying a reaction liquid that reacts with the ink, a step of curing an image via irradiation with an active energy ray or the like, and a step of heating the image).

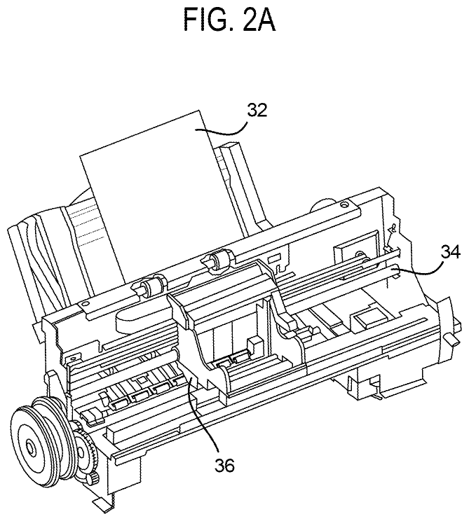

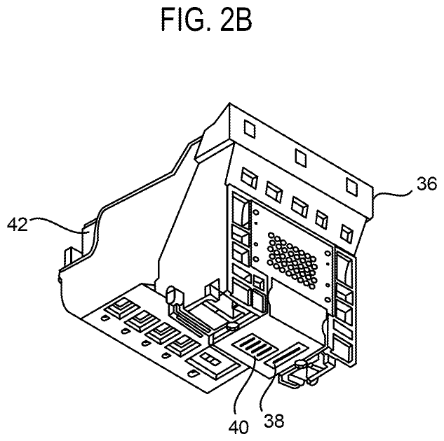

FIGS. 2A and 2B are views schematically illustrating one example of an ink jet recording apparatus for use in the ink jet recording method of the present invention. FIG. 2A is a perspective view of a main part of the ink jet recording apparatus, and FIG. 2B is a perspective view of a head cartridge. The ink jet recording apparatus is provided with a conveyance unit (not illustrated) that conveys a recording medium 32 and a carriage shaft 34. A head cartridge 36 can be mounted on the carriage shaft 34. The head cartridge 36 includes recording heads 38 and 40 and is configured such that an ink cartridge 42 can be set thereon. While the head cartridge 36 is conveyed in the main scanning direction along the carriage shaft 34, the ink (not illustrated) is ejected from the recording heads 38 and 40 toward the recording medium 32. Moreover, the recording medium 32 is conveyed in the sub scanning direction by the conveyance unit (not illustrated). As a result, an image is recorded onto the recording medium 32.

In this ink jet recording method, an ink jet recording apparatus including a recording head can be used to scan the recording head a plurality of times over a unit region of a recording medium. It is preferable to perform a step in which the ink to be used to record an image of a unit region of the recording medium is applied in a divided amount a plurality of times onto the unit region. In other words, it is preferable to record an image of a unit region of the recording medium by so-called “multi-pass recording” in which an image is recorded by scanning the recording head a plurality of times. “Unit region” refers to one pixel, a region divided into any number of pixels, one band or the like, and can be set to be any of various regions as appropriate. Also, one pixel means a single pixel based on the resolution, and one band means a region in an image to be formed by a single scan of the recording head.

In the case of recording an image of a unit region of the recording medium by so-called “single-pass recording” in which an image is recorded by scanning the recording head once, the amount of the ink to be applied to the unit region of the recording medium in the single scan is larger than that in multi-pass recording. Consequently, there may be an excess ink having failed to be absorbed by the recording medium, and dots may integrate with each other. This may cause density unevenness.

Incidentally, in the step of applying the ink onto a unit region of the recording medium in a divided amount a plurality of times (multi-pass recording), the time interval between the plurality of scans over the unit region is preferably 1 second or more to 10 seconds or less. If the time interval between the scans is shorter than 1 second, the (N+1)-th scan is performed before the ink applied in the N-th scan sufficiently permeates the recording medium, and the ink is applied onto the same unit region of the recording medium. Consequently, there may be an excess ink having failed to be absorbed by the recording medium, and ink droplets may integrate with each other. This may cause density unevenness. If the time interval between the scans is longer than 10 seconds, the orientation of the silicone-based surfactant at the surfaces of dots formed by the ink applied onto a unit region of the recording medium in the N-th or older scan has already progressed when the ink is applied to the same unit region of the recording medium in the (N+1)-th scan. Thus, the dot surfaces are slippery and the ink droplets repel each other. This may slightly lower the beading resistance.

Any type of recording medium may be used as the recording medium to record an image by the ink jet recording method of the present invention. In particular, it is preferable to use a permeable paper, e.g., a recording medium without no coating layer, such as plain paper or uncoated paper, or a recording medium with a coating layer, such as glossy paper or art paper. Of these, it is preferable to use the recording medium with a coating layer, and particularly preferable to use glossy paper.

### EXAMPLES

Hereinafter, the present invention will be described in more detail based on Examples and Comparative Examples. However, the present invention is by no means limited to the following Examples as long as the gist thereof is not exceeded. The amounts of components represented by “part(s)” and “%” are based on mass, unless otherwise noted.

<Preparation of Resins>

(Resin 1)

A styrene/n-butyl acrylate/acrylic acid copolymer synthesized in a usual manner (copolymerization ratio [by mass]: 57/29/14) was prepared as a resin 1. This resin 1 was dissolved in water containing potassium hydroxide equimolar to the acid value of the resin to prepare an aqueous solution of the resin 1 in which the content of the resin 1 was 10.00%.

(Resin 2)

An acrylic-based resin having an acid value of 215 mgKOH/g and a weight average molecular weight of 8,500 (trade name “JONCRYL 678”, manufactured by BASF SE) was prepared as a resin 2. This resin 2 was dissolved in water containing potassium hydroxide in an amount 0.95 times (molar ratio) the acid value of the resin to prepare an aqueous solution of the resin 2 in which the content of the resin 2 was 10.00%.

(Resin 3)

In a four-necked flask equipped with a thermometer, a stirrer, a nitrogen introduction pipe and a cooling pipe, 39.3 g of polypropylene glycol (number average molecular weight: 1,000), 44.5 g of isophorone diisocyanate and 0.007 g of dibutyl tin dilaurate were charged. Under a nitrogen gas atmosphere, the mixture was reacted at a temperature of 100° C. for 5 hours and then cooled down to a temperature of 65° C. or less. 13.2 g of dimethylol propionic acid, 3.0 g of neopentyl glycol and 150.0 g of methyl ethyl ketone were added, and the mixture was reacted at a temperature of 80° C. The mixture was then cooled down to a temperature of 40° C., and 20.0 g of methanol was added to terminate the reaction. Then, an appropriate amount of ion-exchanged water was added, and an aqueous solution of potassium hydroxide necessary for neutralizing the resin was added with stirring with a homomixer. Thereafter, the methyl ethyl ketone and the unreacted methanol were distilled away by heating under reduced pressure. As a result, an aqueous solution of a resin 3 being a water-soluble urethane resin was obtained in which the content of the resin 3 was 10.00%. The acid value of the resin 3 was 55 mgKOH/g, and its weight average molecular weight was 15,000.

(Resin 4)

An acrylic-based resin having an acid value of 160 mgKOH/g and a weight average molecular weight of 8,000 (trade name “JONCRYL 683”, manufactured by BASF SE) was prepared as a resin 4. This resin 4 was dissolved in water containing potassium hydroxide equimolar to the acid value of the resin to prepare an aqueous solution of the resin 4 in which the content of the resin 4 was 10.00%.

<Preparation of Pigment Dispersion Liquids>

(Pigment Dispersion Liquid 1)

A pigment dispersion liquid was prepared by mixing 10.0 parts of a pigment (C.I. Pigment Blue 15:3), 50.0 parts of the aqueous solution of the resin 1 and 40.0 parts of ion-exchanged water, followed by dispersion for 3 hours with a batch-type vertical sand mill. The obtained dispersion liquid was filtered under pressure through a filter with a pore size of 2.5 μm (product name: HDCII, manufactured by Nihon Pall Ltd.). Water was added to this dispersion liquid. As a result, a pigment dispersion liquid 1 was prepared in which the content of the pigment was 10.00% and the content of the resin dispersant was 5.00%.

(Pigment Dispersion Liquid 2)

A pigment dispersion liquid was prepared by mixing 10.0 parts of a pigment (C.I. Pigment Blue 15:3), 50.0 parts of the aqueous solution of the resin 2 and 40.0 parts of ion-exchanged water, followed by dispersion for 3 hours with a batch-type vertical sand mill. The obtained dispersion liquid was filtered under pressure through a filter with a pore size of 2.5 μm (product name: HDCII, manufactured by Nihon Pall Ltd.). Water was added to this dispersion liquid. As a result, a pigment dispersion liquid 2 was prepared in which the content of the pigment was 10.00% and the content of the resin dispersant was 5.00%.

(Pigment Dispersion Liquid 3)

Based on Japanese Patent Application Laid-Open No. 2016-190981, a pigment dispersion liquid was prepared by mixing 10.0 parts of a pigment (C.I. Pigment Blue 15:3) and 90.0 parts of ion-exchanged water, followed by dispersion for 3 hours with a batch-type vertical sand mill. The obtained dispersion liquid was filtered under pressure through a filter with a pore size of 2.5 μm (product name: HDCII, manufactured by Nihon Pall Ltd.). Water was added to this dispersion liquid. As a result, a pigment dispersion liquid 3 was prepared in which the content of the pigment was 10.00%.

<Preparation of Surfactants>

Compounds A1 to A11 and A13 to A19 as well as a compound A12 to be described later were prepared. A11 of these are listed in Tables 1 to 3 and are silicone-based surfactants. In Tables 1 to 3, each compound's “number of moles of ethylene oxide added/degree of polysiloxane polymerization” is abbreviated as “Ratio”.

(Compounds Represented by General Formula (1))

A polysiloxane compound represented by following Formula (8) and a polyoxyethylene compound represented by following Formula (9) were charged into a glass container equipped with a thermometer and a stirrer. These compounds were subjected to an addition reaction in the presence of a platinum catalyst. The compounds A1 to A11, A13 and A14 having the structures represented by General Formula (1) were each synthesized in this manner. Table 1 shows properties of the synthesized compounds such as HLB value and weight average molecular weight (Mw). In Table 1, a, p, R₁ and R₂ correspond respectively to a, p, R₁ and R₂ in General Formula (1) representing the structure of each synthesized compound. “Ratio” in the table corresponds to the value of 2a/p. The compound A12 is a silicone-based surfactant having the structure represented by General Formula (1) (trade name “BYK-333”, manufactured by BYK-Chemie GmbH, HLB value: 10, weight average molecular weight: 8,000).

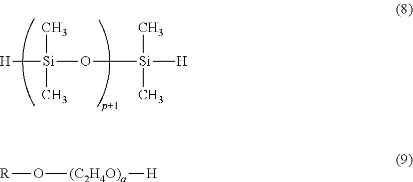

TABLE 1
Properties of Compounds Represented by General Formula (1)

| | HLB | | | | | | Ratio |
|---|---|---|---|---|---|---|---|
| Compound | Value | Mw | a | P | R₁ | R₂ | (2a/p) |
| A1 | 14 | 2,200 | 11 | 7 | Hydrogen | Propylene | 3.1 |
| | | | | | atom | group | |
| A2 | 14 | 1,500 | 11 | 6 | Hydrogen | Propylene | 3.7 |
| | | | | | atom | group | |
| A3 | 13 | 7,500 | 55 | 42 | Hydrogen | Propylene | 2.6 |
| | | | | | atom | group | |
| A4 | 8 | 2,800 | 12 | 26 | Hydrogen | Propylene | 0.9 |
| | | | | | atom | group | |
| A5 | 9 | 2,600 | 12 | 24 | Hydrogen | Propylene | 1.0 |
| | | | | | atom | group | |
| A6 | 15 | 2,200 | 20 | 4 | Hydrogen | Propylene | 10.0 |
| | | | | | atom | group | |
| A7 | 17 | 2,600 | 24 | 4 | Hydrogen | Propylene | 12.0 |
| | | | | | atom | group | |
| A8 | 14 | 900 | 6 | 4 | Hydrogen | Propylene | 3.0 |
| | | | | | atom | group | |
| A9 | 14 | 10,000 | 80 | 50 | Hydrogen | Propylene | 3.2 |
| | | | | | atom | group | |
| A10 | 10 | 47,000 | 240 | 349 | Hydrogen | Propylene | 1.4 |
| | | | | | atom | group | |
| A11 | 8 | 11,000 | 50 | 85 | Hydrogen | Propylene | 1.2 |
| | | | | | atom | group | |
| A13 | 18.5 | 6,900 | 71 | 1 | Hydrogen | Propylene | 142.0 |
| | | | | | atom | group | |
| A14 | 19 | 7,000 | 75 | 1 | Hydrogen | Propylene | 150.0 |
| | | | | | atom | group | |

(Compounds Represented by General Formula (3))

A polysiloxane compound represented by following Formula (10) and a polyoxyethylene compound represented by following Formula (11) were charged into a glass container equipped with a thermometer and a stirrer. These compounds were subjected to an addition reaction in the presence of a platinum catalyst. The compounds A15 to A18 represented by General Formula (3) were each synthesized in this manner. Table 2 shows properties of the synthesized compounds such as HLB value and weight average molecular weight (Mw). In Table 2, b, q, r, R₃ and R₄ correspond respectively to b, q, r, R₃ and R₄ in General Formula (3) representing the structure of each synthesized compound. “Ratio” in the table corresponds to the value of b×r/(q+r).

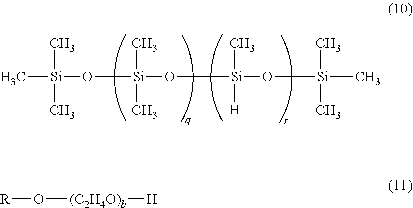

TABLE 2
Properties of Compounds Represented by General Formula (3)

| | | | | | | | | Ratio |
|---|---|---|---|---|---|---|---|---|
| | HLB | | | | | | | (b × r/ |
| Compound | Value | Mw | b | q | r | R3 | R4 | (q + r)) |
| A15 | 8 | 7,100 | 60 | 25 | 2 | Hydrogen | Propylene | 4.4 |
| | | | | | | atom | group | |
| A16 | 11 | 2,800 | 13 | 2 | 1 | Hydrogen | Propylene | 4.3 |
| | | | | | | atom | group | |
| A17 | 3 | 480 | 1 | 3 | 1 | Methyl | Propylene | 0.3 |
| | | | | | | group | group | |
| A18 | 10 | 500 | 6 | 0 | 1 | Methyl | Propylene | 6.0 |
| | | | | | | group | group | |

(Compound Represented by General Formula (4))

A polysiloxane compound represented by following Formula (12) and a polyoxyethylene compound represented by following Formula (13) were charged into a glass container equipped with a thermometer and a stirrer. These compounds were subjected to an addition reaction in the presence of a platinum catalyst. The compound A19 represented by General Formula (4) was synthesized in this manner. Table 3 shows properties of the synthesized compound 19 such as HLB value and weight average molecular weight (Mw). In Table 3, c, s, t, R₅ and R₆ correspond respectively to c, s, t, R₅ and R₆ in General Formula (4) representing the structure of the synthesized compound 19. “Ratio” in the table corresponds to the value of (c+c×t)/s×t.

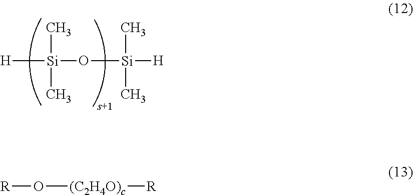

TABLE 3
Properties of Compound Represented by General Formula (4)

| | | | | | | | | Ratio |
|---|---|---|---|---|---|---|---|---|
| | | | | | | | | ((c + |
| | HLB | | | | | | | c × t)/ |
| Compound | Value | Mw | c | s | t | R5 | R6 | s × t) |
| A19 | 9 | 7,000 | 17 | 20 | 3 | propyl | Propylene | 1.1 |
| | | | | | | group | group | |

(Compounds Represented by General Formula (2) and Other Surfactants)

Compounds B1 to B4 and C1 to C3 listed in Table 4 were prepared. In Table 4, “PRESENT” shown in the column “General Formula (2)” means a compound represented by General Formula (2) (acetylene glycol-based surfactant), while “ABSENT” means another surfactant not represented by General Formula (2).

TABLE 4
Properties of Compounds Represented by
General Formula (2) and other Surfactants

| | | General | | HLB |
|---|---|---|---|---|
| Compound | | Formula (2) | Structure | Value |
| B1 | SURFYNOL 440 | PRESENT | Ethylene oxide adduct | 8 |
| | (trade name, manufactured | | of acetylene glycol | |
| | by Nissin Chemical Industry | | | |
| | Co., Ltd) | | | |
| B2 | SURFYNOL 465 | PRESENT | Ethylene oxide adduct | 13 |
| | (trade name, manufactured | | of acetylene glycol | |
| | by Nissin Chemical Industry | | | |
| | Co., Ltd) | | | |
| B3 | SURFYNOL 104PG50 | PRESENT | Ethylene oxide | 4 |
| | (trade name, manufactured | | compound | |
| | by Nissin Chemical Industry | | | |
| | Co., Ltd) | | | |
| B4 | ACETYLENOL E100 | PRESENT | Ethylene oxide adduct | 13 |
| | (trade name, manufactured | | of acetylene glycol | |
| | by Kawaken Fine Chemicals | | | |
| | Co., Ltd.) | | | |
| C1 | NIKKOL BC-15 | ABSENT | Polyoxyethylene cetyl | 15 |
| | (trade name, manufactured | | ether | |
| | by Nikko Chemicals Co., | | | |
| | Ltd.) | | | |
| C2 | NIKKOL BC-20 | ABSENT | Polyoxyethylene cetyl | 16 |
| | (trade name, manufactured | | ether | |
| | by Nikko Chemicals Co., | | | |
| | Ltd.) | | | |
| C3 | Capstone FS3100 | ABSENT | Perfluoroalkyl | 10 |
| | (trade name, manufactured | | ethylene oxide adduct | |
| | by DuPont de Nemours, Inc.) | | | |

<Preparation of Inks>

Components (unit: %) listed in a middle section of Table 5 were mixed, sufficiently stirred and filtered under pressure through a polypropylene filter with a pore size of 1.0 μm (manufactured by ADVANTEC CO., LTD.) to prepare inks. A lower section of Table 5 shows the content A (%) of each of the silicone-based surfactants (compounds 1 to 19) and the content B (%) of each of the acetylene glycol-based surfactants (the compounds represented by General Formula (2) in Table 4) based on the total mass of the ink, as well as the values of A/(A+B) and A+B. Moreover, γₛ(mN/m) shown in the lower section of Table 5 is the value of the static surface tension of each ink measured using a Wilhelmy-type surface tension meter (trade name “Automatic Surface Tensiometer CBVP-Z”, manufactured by Kyowa Interface Science Co., Ltd.) under a 25° C. condition. Also, γ₁₀(mN/m) is the value of the dynamic surface tension of each ink at a lifetime of 10 milliseconds measured using a dynamic surface tension meter using the maximum bubble pressure method under a 25° C. condition. The trade name “BUBBLE PRESSURE TENSIOMETER BP-100” (manufactured by KRÜSS GmbH) was used as the dynamic surface tension meter. The lower section of Table 5 also shows the value of |γ₁₀−γₛ| (mN/m). Furthermore, “Absolute Value of Difference in HLB Value” shown in the lower section of Table 5 represents the absolute value of the difference between the HLB value of each ink's silicone-based surfactant (one of the compounds 1 to 19) and the HLB value of the ink's acetylene glycol-based surfactant (one of the compounds represented by General Formula (2) in Table 4).

TABLE 5
Compositions and Properties of Inks

| | Ink | | | | | | |
|---|---|---|---|---|---|---|---|
| | 1 | 2 | 3 | 4 | 5 | 6 | 7 |
| Kind of Compound A | A1 | A1 | A1 | A2 | A3 | A1 | A1 |
| Kind of Compound B | B1 | B2 | B1 | B1 | B1 | B3 | B1 |
| Kind of Compound C | — | — | C1 | — | — | — | — |
| Pigment Dispersion Liquid 1 | 28.00 | 28.00 | 28.00 | 28.00 | 28.00 | 28.00 | 28.00 |
| Pigment Dispersion Liquid 2 | | | | | | | |
| Pigment Dispersion Liquid 3 | | | | | | | |
| Aqueous Solution of Resin 1 | 10.00 | 10.00 | 10.00 | 10.00 | 10.00 | 10.00 | 10.00 |
| Aqueous Solution of Resin 3 | | | | | | | |
| Aqueous Solution of Resin 4 | | | | | | | |
| Kind of Compound A | 0.25 | 0.10 | 0.25 | 0.25 | 0.25 | 0.25 | 0.25 |
| at upper section | | | | | | | |
| Kind of Compound B | 0.50 | 0.30 | 0.50 | 0.50 | 0.50 | 0.38 | 0.75 |
| at upper section | | | | | | | |
| Kind of Compound C | | | 0.20 | | | | |
| at upper section | | | | | | | |
| Glycerin | 5.00 | 5.00 | 5.00 | 5.00 | 5.00 | 5.00 | 5.00 |
| Diethylene Glycol | 5.00 | 5.00 | 5.00 | 5.00 | 5.00 | 5.00 | 5.00 |
| Triethylene Glycol | | | | | | | |
| Polyethylene Glycol | 5.00 | 5.00 | 5.00 | 5.00 | 5.00 | 5.00 | 5.00 |
| (Mn: 1,000) | | | | | | | |
| 1,2-hexanediol | 2.00 | 7.50 | 2.00 | 2.00 | 2.00 | 2.00 | |
| Ion-exchanged Water | 44.25 | 39.10 | 44.05 | 44.25 | 44.25 | 44.37 | 46.00 |
| Content A (%) of | 0.25 | 0.10 | 0.25 | 0.25 | 0.25 | 0.25 | 0.25 |
| Silicone-based Surfactant | | | | | | | |
| Content B (%) of | 0.50 | 0.30 | 0.50 | 0.50 | 0.50 | 0.38 | 0.75 |
| Acetylene Glycol-based | | | | | | | |
| Surfactant | | | | | | | |
| Value of A/(A + B) | 0.33 | 0.25 | 0.33 | 0.33 | 0.33 | 0.40 | 0.25 |
| Value (%) of A + B | 0.75 | 0.40 | 0.75 | 0.75 | 0.75 | 0.63 | 1.00 |
| γₛ (mN/m) | 31.5 | 31.9 | 31.2 | 31.5 | 31.5 | 29.4 | 29.5 |
| γ₁₀ (mN/m) | 37.0 | 36.4 | 36.8 | 37.0 | 37.0 | 37.9 | 34.0 |
| \|γ₁₀-γₛ\| (mN/m) | 5.5 | 4.5 | 5.6 | 5.5 | 5.5 | 8.5 | 4.5 |
| Absolute Value of | 6 | 1 | 6 | 6 | 5 | 10 | 6 |
| Difference in HLB Value | | | | | | | |
| | Ink | | | | | | |
| | 8 | 9 | 10 | 11 | 12 | 13 | 14 |
| Kind of Compound A | A1 | A1 | A1 | A1 | A1 | A1 | A1 |
| Kind of Compound B | B1 | B1 | B1 | B1 | B3 | B3 | B3 |
| Kind of Compound C | — | — | — | — | — | — | — |
| Pigment Dispersion Liquid 1 | 28.00 | 28.00 | 28.00 | 28.00 | 28.00 | 28.00 | 28.00 |
| Pigment Dispersion Liquid 2 | | | | | | | |
| Pigment Dispersion Liquid 3 | | | | | | | |
| Aqueous Solution of Resin 1 | 10.00 | 10.00 | 10.00 | 10.00 | 10.00 | 10.00 | 10.00 |
| Aqueous Solution of Resin 3 | | | | | | | |
| Aqueous Solution of Resin 4 | | | | | | | |
| Kind of Compound A | 0.20 | 0.25 | 0.25 | 0.25 | 0.25 | 0.25 | 0.25 |
| at upper section | | | | | | | |
| Kind of Compound B | 0.50 | 0.50 | 0.60 | 0.55 | 0.45 | 0.70 | 0.50 |
| at upper section | | | | | | | |
| Kind of Compound C | | | | | | | |
| at upper section | | | | | | | |
| Glycerin | 5.00 | 5.00 | 5.00 | 5.00 | 5.00 | 5.00 | 5.00 |
| Diethylene Glycol | 5.00 | 5.00 | 5.00 | 5.00 | 5.00 | 5.00 | 5.00 |
| Triethylene Glycol | | | | | | | |
| Polyethylene Glycol | 5.00 | 5.00 | 5.00 | 5.00 | 5.00 | 5.00 | 5.00 |
| (Mn: 1,000) | | | | | | | |
| 1,2-hexanediol | 2.00 | | 2.00 | 2.00 | | | |
| Ion-exchanged Water | 44.30 | 46.25 | 44.15 | 44.20 | 46.30 | 46.05 | 46.25 |
| Content A (%) of | 0.20 | 0.25 | 0.25 | 0.25 | 0.25 | 0.25 | 0.25 |
| Silicone-based Surfactant | | | | | | | |
| Content B (%) of | 0.50 | 0.50 | 0.60 | 0.55 | 0.45 | 0.70 | 0.50 |
| Acetylene Glycol-based | | | | | | | |
| Surfactant | | | | | | | |
| Value of A/(A + B) | 0.29 | 0.33 | 0.29 | 0.31 | 0.36 | 0.26 | 0.33 |
| Value (%) of A + B | 0.70 | 0.75 | 0.85 | 0.80 | 0.70 | 0.95 | 0.75 |
| γₛ (mN/m) | 32.0 | 35.0 | 30.5 | 31.0 | 27.0 | 23.0 | 28.2 |
| γ₁₀ (mN/m) | 37.5 | 41.0 | 34.3 | 35.0 | 37.0 | 35.0 | 35.6 |
| \|γ₁₀-γₛ\| (mN/m) | 5.5 | 6.0 | 3.8 | 4.0 | 10.0 | 12.0 | 7.4 |
| Absolute Value of | 6 | 6 | 6 | 6 | 10 | 10 | 10 |
| Difference in HLB Value | | | | | | | |

| | Ink | | | | | | |
|---|---|---|---|---|---|---|---|
| | 15 | 16 | 17 | 18 | 19 | 20 | 21 |
| Kind of Compound A | A6 | A4 | A5 | A6 | A7 | A13 | A14 |
| Kind of Compound B | B3 | B1 | B1 | B1 | B1 | B2 | B2 |
| Kind of Compound C | — | — | — | — | — | — | — |
| Pigment Dispersion Liquid 1 | 28.00 | 28.00 | 28.00 | 28.00 | 28.00 | 28.00 | 28.00 |
| Pigment Dispersion Liquid 2 | | | | | | | |
| Pigment Dispersion Liquid 3 | | | | | | | |
| Aqueous Solution of Resin 1 | 10.00 | 10.00 | 10.00 | 10.00 | 10.00 | 10.00 | 10.00 |
| Aqueous Solution of Resin 3 | | | | | | | |
| Aqueous Solution of Resin 4 | | | | | | | |
| Kind of Compound A | 0.05 | 0.25 | 0.25 | 0.25 | 0.25 | 0.25 | 0.25 |
| at upper section | | | | | | | |
| Kind of Compound B | 0.10 | 0.50 | 0.50 | 0.50 | 0.50 | 0.50 | 0.50 |
| at upper section | | | | | | | |
| Kind of Compound C | | | | | | | |
| at upper section | | | | | | | |
| Glycerin | 5.00 | 5.00 | 5.00 | 5.00 | 5.00 | 5.00 | 5.00 |
| Diethylene Glycol | 5.00 | 5.00 | 5.00 | 5.00 | 5.00 | | |
| Triethylene Glycol | | | | | | | |
| Polyethylene Glycol | 5.00 | 5.00 | 5.00 | 5.00 | 5.00 | 10.00 | 10.00 |
| (Mn: 1,000) | | | | | | | |
| 1,2-hexanediol | 2.00 | 2.00 | 2.00 | 2.00 | 2.00 | | |
| ion-exchanged Water | 44.85 | 44.25 | 44.25 | 44.25 | 44.25 | 46.25 | 46.25 |
| Content A (%) of | 0.05 | 0.25 | 0.25 | 0.25 | 0.25 | 0.25 | 0.25 |
| Silicone-based Surfactant | | | | | | | |
| Content B (%) of | 0.10 | 0.50 | 0.50 | 0.50 | 0.50 | 0.50 | 0.50 |
| Acetylene Glycol-based | | | | | | | |
| Surfactant | | | | | | | |
| Value of A/(A + B) | 0.33 | 0.33 | 0.33 | 0.33 | 0.33 | 0.33 | 0.33 |
| Value (%) of A + B | 0.15 | 0.75 | 0.75 | 0.75 | 0.75 | 0.75 | 0.75 |
| γₛ (mN/m) | 31.1 | 30.5 | 31.0 | 31.5 | 31.7 | 30.0 | 30.0 |
| γ₁₀ (mN/m) | 38.3 | 35.0 | 36.5 | 37.0 | 37.0 | 35.0 | 35.0 |
| \|γ₁₀-γₛ\| (mN/m) | 7.2 | 4.5 | 5.5 | 5.5 | 5.3 | 5.0 | 5.0 |
| Absolute Value of | 11 | 0 | 1 | 7 | 9 | 5.5 | 6 |
| Difference in HLB Value | | | | | | | |
| | Ink | | | | | | |
| | 22 | 23 | 24 | 25 | 26 | 27 | 28 |
| Kind of Compound A | A7 | A15 | A16 | A19 | — | A8 | A9 |
| Kind of Compound B | B3 | B1 | B1 | B1 | B1 | B1 | B1 |
| Kind of Compound C | — | — | — | — | — | — | — |
| Pigment Dispersion Liquid 1 | 28.00 | 28.00 | 28.00 | 28.00 | 28.00 | 28.00 | 28.00 |
| Pigment Dispersion Liquid 2 | | | | | | | |
| Pigment Dispersion Liquid 3 | | | | | | | |
| Aqueous Solution of Resin 1 | 10.00 | 10.00 | 10.00 | 10.00 | 10.00 | 10.00 | |
| Aqueous Solution of Resin 3 | | | | | | | |
| Aqueous Solution of Resin 4 | | | | | | | |
| Kind of Compound A | 0.25 | 0.25 | 0.25 | 0.25 | | 0.25 | 0.25 |
| at upper section | | | | | | | |
| Kind of Compound B | 0.50 | 0.50 | 0.50 | 0.50 | 0.60 | 0.50 | 0.50 |
| at upper section | | | | | | | |
| Kind of Compound C | | | | | | | |
| at upper section | | | | | | | |
| Glycerin | 5.00 | 5.00 | 5.00 | 5.00 | 5.00 | 5.00 | 5.00 |
| Diethylene Glycol | 5.00 | 5.00 | 5.00 | 5.00 | 5.00 | 5.00 | 5.00 |
| Triethylene Glycol | | | | | | | |
| Polyethylene Glycol | 5.00 | 5.00 | 5.00 | 5.00 | 5.00 | 5.00 | 5.00 |
| (Mn: 1,000) | | | | | | | |
| 1,2-hexanediol | 2.00 | 2.00 | 2.00 | 2.00 | 2.00 | 2.00 | 2.00 |
| ion-exchanged Water | 44.25 | 44.25 | 44.25 | 44.25 | 44.40 | 44.25 | 54.25 |
| Content A (%) of | 0.25 | 0.25 | 0.25 | 0.25 | 0.00 | 0.25 | 0.25 |
| Silicone-based Surfactant | | | | | | | |
| Content B (%) of | 0.50 | 0.50 | 0.50 | 0.50 | 0.60 | 0.50 | 0.50 |
| Acetylene Glycol-based | | | | | | | |
| Surfactant | | | | | | | |
| Value of A/(A + B) | 0.33 | 0.33 | 0.33 | 0.33 | 0.00 | 0.33 | 0.33 |
| Value (%) of A + B | 0.75 | 0.75 | 0.75 | 0.75 | 0.60 | 0.75 | 0.75 |
| γₛ (mN/m) | 32.5 | 30.5 | 30.5 | 30.0 | 31.8 | 31.5 | 31.0 |
| γ₁₀ (mN/m) | 36.0 | 36.5 | 36.5 | 36.0 | 36.0 | 37.0 | 36.5 |
| \|γ₁₀-γₛ\| (mN/m) | 3.5 | 6.0 | 6.0 | 6.0 | 4.2 | 5.5 | 5.5 |
| Absolute Value of | 13 | 0 | 3 | 1 | — | 6 | 6 |
| Difference in HLB Value | | | | | | | |

| | Ink | | | | |
|---|---|---|---|---|---|
| | 29 | 30 | 31 | 32 | 33 |
| Kind of Compound A | A10 | A1 | A1 | A1 | A1 |
| Kind of Compound B | B1 | — | — | — | B1 |
| Kind of Compound C | — | — | C2 | C3 | — |
| Pigment Dispersion Liquid 1 | 28.00 | 28.00 | 28.00 | 28.00 | 28.00 |
| Pigment Dispersion Liquid 2 | | | | | |
| Pigment Dispersion Liquid 3 | | | | | |
| Aqueous Solution of Resin 1 | 10.00 | 10.00 | 10.00 | 10.00 | 10.00 |
| Aqueous Solution of Resin 3 | | | | | |
| Aqueous Solution of Resin 4 | | | | | |
| Kind of Compound A | 0.25 | 1.00 | 0.25 | 0.25 | 0.50 |
| at upper section | | | | | |
| Kind of Compound B | 0.50 | | | | 0.50 |
| at upper section | | | | | |
| Kind of Compound C | | | 0.50 | 0.10 | |
| at upper section | | | | | |
| Glycerin | 5.00 | 5.00 | 5.00 | 5.00 | 5.00 |
| Diethylene Glycol | 5.00 | 5.00 | 5.00 | 5.00 | 5.00 |
| Triethylene Glycol | | | | | |
| Polyethylene Glycol | 5.00 | 5.00 | 5.00 | 5.00 | 5.00 |
| (Mn: 1,000) | | | | | |
| 1,2-hexane diol | 2.00 | 12.00 | 2.00 | 2.00 | 2.00 |
| Ion-exchanged Water | 44.25 | 34.00 | 44.25 | 44.65 | 44.00 |
| Content A (%) of | 0.25 | 1.00 | 0.25 | 0.25 | 0.50 |
| Silicone-based Surfactant | | | | | |
| Content B (%) of | 0.50 | 0.00 | 0.00 | 0.00 | 0.50 |
| Acetylene Glycol-based | | | | | |
| Surfactant | | | | | |
| Value of A/(A + B) | 0.33 | 1.00 | 1.00 | 1.00 | 0.50 |
| Value (%) of A + B | 0.75 | 1.00 | 0.25 | 0.25 | 1.00 |
| γₛ (mN/m) | 31.2 | 31.1 | 31.5 | 26.0 | 30.8 |
| γ₁₀ (mN/m) | 37.0 | 39.6 | 37.0 | 34.0 | 36.0 |
| \|γ₁₀-γₛ\| (mN/m) | 5.8 | 8.5 | 5.5 | 8.0 | 5.2 |
| Absolute Value of | 2 | — | — | — | 6 |
| Difference in HLB Value | | | | | |
| | Ink | | | | |
| | 34 | 35 | 36 | 37 | 38 |
| Kind of Compound A | A1 | A10 | A11 | A12 | A17 + A18 |
| Kind of Compound B | B1 | — | B4 | B4 | — |
| Kind of Compound C | — | — | — | — | — |
| Pigment Dispersion Liquid 1 | 28.00 | 28.00 | | | |
| Pigment Dispersion Liquid 2 | | | 10.00 | 10.00 | |
| Pigment Dispersion Liquid 3 | | | | | 50.00 |
| Aqueous Solution of Resin 1 | 10.00 | 26.00 | | | |
| Aqueous Solution of Resin 3 | | | 4.00 | 1.00 | |
| Aqueous Solution of Resin 4 | | | 8.00 | 8.00 | |
| Kind of Compound A | 0.25 | 0.25 | 0.15 | 0.25 | 0.50 + 0.50 |
| at upper section | | | | | |
| Kind of Compound B | 1.00 | | 1.00 | 1.00 | |
| at upper section | | | | | |
| Kind of Compound C | | | | | |
| at upper section | | | | | |
| Glycerin | 5.00 | 5.00 | 10.00 | 10.00 | 5.00 |
| Diethylene Glycol | 5.00 | 5.00 | | | |
| Triethylene Glycol | | | 5.00 | 5.00 | |
| Polyethylene Glycol | 5.00 | 5.00 | | | 10.00 |
| (Mn: 1,000) | | | | | |
| 1,2-hexane diol | | | 5.00 | 5.00 | |
| Ion-exchanged Water | 45.75 | 30.75 | 56.85 | 59.75 | 34.00 |
| Content A (%) of | 0.25 | 0.25 | 0.15 | 0.25 | 1.00 |
| Silicone-based Surfactant | | | | | |
| Content B (%) of | 1.00 | 0.00 | 1.00 | 1.00 | 0.00 |
| Acetylene Glycol-based | | | | | |
| Surfactant | | | | | |
| Value of A/(A + B) | 0.20 | 1.00 | 0.13 | 0.20 | 1.00 |
| Value (%) of A + B | 1.25 | 0.25 | 1.15 | 1.25 | 1.00 |
| γₛ (mN/m) | 25.5 | 39.0 | 31.8 | 31.9 | 26.0 |
| γ₁₀ (mN/m) | 30.0 | 61.0 | 36.0 | 37.0 | 32.0 |
| \|γ₁₀-γₛ\| (mN/m) | 4.5 | 22.0 | 4.2 | 5.1 | 6.0 |
| Absolute Value of | 6 | — | 5 | 3 | — |
| Difference in HLB Value | | | | | |

<Evaluation>

Each of the prepared inks was filled in an ink cartridge, which was then set in an ink jet recording apparatus (trade name “imagePROGRAF PRO-1000”, manufactured by Canon Inc.) equipped with a recording head for ejecting an ink by thermal energy. In Examples, a solid image recorded by applying 30 ng of an ink to a 1/600 inch× 1/600 inch unit region is defined as an image with “a recording duty of 100%”. In the present invention, the evaluation criteria of each item below are such that “A”, “B” and “B⁻” are acceptable levels, and “C” and “D” are unacceptable levels. Table 7 shows the evaluation conditions and evaluation results.

(Abrasion Resistance)

Using the ink jet recording apparatus mentioned above, a solid image with a recording duty of 10% was recorded on a recording medium (trade name “Canon Photo Paper Glossy Pro [Platinum Grade]”, manufactured by Canon Inc.). The ink was applied to a unit region by scanning (passing) the recording head in the main scanning direction once or four times. For the four-pass recording, a wait time was set for each point when the recording head switched its reciprocating movement such that the recording interval between passes would be a predetermined period of time (time interval). The image recorded under the above conditions was left to stand for 1 minute. Then, on the image, a sheet of silbon paper was placed with a weight with a contact pressure of 300 g/cm² and a weight with a contact pressure of 500 g/cm² thereon, and the recorded product and the sheet of lens cleaning paper were rubbed against each other. Thereafter, the sheet of silbon paper and the weights were removed, and the image and dirt on the non-recording portion were visually observed to evaluate the abrasion resistance of the image based on the following evaluation criteria.

A: The non-recording portion was not soiled or the image was not worn off with either of the weights.

B: The non-recording portion was not soiled or the image was not worn off with the weight with a contact pressure of 300 g/cm², but the image was scratched but not worn off with the weight with a contact pressure of 500 g/cm².

B⁻: The image was scratched with both of the weights but was not worn off.

C: The non-recording portion was soiled and the image was worn off with both of the weights, and the area of the worn portion was half of the image or less.

D: The non-recording portion was soiled and the image was worn off with both of the weights, and the area of the worn portion was more than half of the image.

(Beading Resistance)

A solid image with a recording duty of 300% was recorded in one pass or four passes on each of the recording media listed in Table 6. These recording media differ in ink permeability. For the four-pass recording, a wait time was set for each point when the recording head switched its reciprocating movement such that the recording interval between passes would be a predetermined period of time. Each image immediately after being recorded was magnified by a factor of 25 and observed to evaluate the beading resistance of the image based on the following evaluation criteria.

A: Unevenness was not observed on none of the recording media, and beading was suppressed.

B: Unevenness was not observed on nine recording media but color unevenness was observed on eight recording media.

C: Unevenness was not observed on 5 recording media but color unevenness was observed on 12 recording media.

D: Color unevenness was observed on all recording media.

TABLE 6
Kinds of Recording Media

| Recording | |
|---|---|
| Medium | Name |
| 1 | Pictorico Proof DCP3 Plus (product name, manufactured by |
| | Pictorico Co., Ltd.) |
| 2 | Pictorico Proof DCP6 (product name, manufactured by |
| | Pictorico Co., Ltd.) |
| 3 | Canon Photo Paper GP-501 (product name, manufactured by |
| | Canon Inc.) |
| 4 | Premium Glossy Paper 2 LFM-GPP2 (product name, |
| | manufactured by Canon Inc.) |
| 5 | Photo Glossy Paper HG LFM-GPH (product name, |
| | manufactured by Canon Inc.) |
| 6 | Glossy Pro Platinum Grade LFM-GPPT (product name, |
| | manufactured by Canon Inc.) |
| 7 | Standard Glossy Paper LFM-GPS (product name, |
| | manufactured by Canon Inc.) |
| 8 | Canon Photo Paper SD-201 (product name, manufactured by |
| | Canon Inc.) |
| 9 | Canon Photo Paper GL-101 (product name, manufactured |
| | by Canon Inc.) |
| 10 | Canon Photo Paper PT-201 (product name, manufactured by |
| | Canon Inc.) |
| 11 | Professional Photo Paper PXMC44R1 (product name, |
| | manufactured by Seiko Epson Corporation) |
| 12 | Photo Paper CRISPIA K6G20SCKR (product name, |
| | manufactured by Seiko Epson Corporation) |
| 13 | Epson Photo Paper KL20PSKR (product name, |
| | manufactured by Seiko Epson Corporation) |
| 14 | Economy Glossy Paper EJK-GUA4100 (product name, |
| | manufactured by Elecom Co., Ltd.) |
| 15 | Glossy Paper EJK-GANA4100 (product name, manufactured |
| | by Elecom Co., Ltd.) |
| 16 | Glossy Premium WPA450PRM (product name, |
| | manufactured by FUJIFILM Corporation) |
| 17 | FUJIFILM Premium Glossy Paper G3A4100A (product |
| | name, manufactured by FUJIFILM Corporation) |

TABLE 7
Evaluation Conditions and Evaluation Results

| | | Evaluation Conditions | | | | |
|---|---|---|---|---|---|---|
| | | | Number | Time | Evaluation Results | |
| | | | of | Interval | Abrasion | Beading |
| | | Ink | Passes | (sec) | Resistance | Resistance |
| Example | 1 | 1 | 4 | 5 | A | A |
| | 2 | 2 | 4 | 5 | A | A |
| | 3 | 3 | 4 | 5 | A | A |
| | 4 | 4 | 4 | 5 | A | A |
| | 5 | 5 | 4 | 5 | A | A |
| | 6 | 6 | 4 | 5 | A | A |
| | 7 | 7 | 4 | 5 | A | A |
| | 8 | 8 | 4 | 5 | A | A |
| | 9 | 9 | 4 | 5 | A | B |
| | 10 | 10 | 4 | 5 | A | B |
| | 11 | 11 | 4 | 5 | A | A |
| | 12 | 12 | 4 | 5 | A | A |
| | 13 | 13 | 4 | 5 | A | B |
| | 14 | 14 | 4 | 5 | A | A |
| | 15 | 15 | 4 | 5 | B | A |
| | 16 | 16 | 4 | 5 | A | B |
| | 17 | 17 | 4 | 5 | A | A |
| | 18 | 18 | 4 | 5 | A | A |
| | 19 | 19 | 4 | 5 | B | A |
| | 20 | 1 | 1 | — | A | B |
| | 21 | 1 | 4 | 0.5 | A | B |
| | 22 | 1 | 4 | 1 | A | A |
| | 23 | 1 | 4 | 10 | A | A |
| | 24 | 1 | 4 | 15 | A | B |
| | 25 | 20 | 4 | 5 | B | A |
| | 26 | 21 | 4 | 5 | B- | A |
| | 27 | 22 | 1 | — | B | B |
| Comparative | 1 | 23 | 4 | 5 | C | C |
| Example | 2 | 24 | 4 | 5 | C | C |
| | 3 | 25 | 4 | 5 | C | C |
| | 4 | 26 | 4 | 5 | D | A |
| | 5 | 27 | 4 | 5 | C | A |
| | 6 | 28 | 4 | 5 | A | C |
| | 7 | 29 | 4 | 5 | A | C |
| | 8 | 30 | 4 | 5 | C | C |
| | 9 | 32 | 4 | 5 | B | C |
| | 10 | 31 | 4 | 5 | B | D |
| | 11 | 33 | 4 | 5 | A | D |
| | 12 | 34 | 4 | 5 | A | D |
| | 13 | 35 | 4 | 5 | A | D |
| | 14 | 36 | 4 | 5 | C | D |
| | 15 | 37 | 4 | 5 | C | D |
| | 16 | 38 | 4 | 5 | C | C |

According to the present invention, it is possible to provide an aqueous ink with which an image having excellent abrasion resistance and beading resistance can be recorded. Also, according to the present invention, it is to provide an ink cartridge and an ink jet recording method using this aqueous ink.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-203244, filed Dec. 15, 2021, and Japanese Patent Application No. 2022-185534, filed Nov. 21, 2022, which are hereby incorporated by reference herein in their entirety.

What is claimed is:

1. An aqueous ink comprising a pigment, a compound (A) represented by following general formula (1) and a compound (B) represented by following general formula (2),
wherein a weight average molecular weight of the compound (A) is 1,500 or more to 7,500 or less,
a ratio of a content A (% by mass) of the compound (A) based on a total mass of the aqueous ink to a sum of the content A (% by mass) of the compound (A) and a content B (% by mass) of the compound (B) based on the total mass of the aqueous ink is 0.40 or less, and
the sum of the content A (% by mass) of the compound (A) and the content B (% by mass) of the compound (B) based on the total mass of the aqueous ink is 1.00% by mass or less; 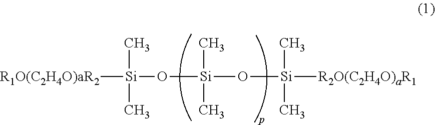
where R₁ represents a hydrogen atom or an alkyl group having 1 or more to 20 or less carbon atoms, R₂ represents an alkylene group having 1 or more to 20 or less carbon atoms, a represents an integer of 1 or more to 170 or less, and p represents an integer of 1 or more to 120 or less, 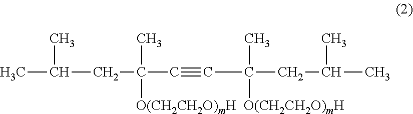
where m and n each independently represent an integer of 0 or more to 15 or less.

2. The aqueous ink according to claim 1, wherein a static surface tension γₛ of the aqueous ink at 25° C. is 32.0 mN/m or less, and
an absolute value |γ₁₀−γₛ| of a difference between a dynamic surface tension γ₁₀ of the aqueous ink at 25° C. at a lifetime of 10 milliseconds and the static surface tension γₛ is 4.0 mN/m or more to 10.0 mN/m or less.

3. The aqueous ink according to claim 1, wherein an absolute value of a difference between a hydrophilic-lipophilic balance (HLB) value of the compound (A) and an HLB value of the compound (B) is 10 or less.

4. The aqueous ink according to claim 1, wherein a ratio (2a/p) of a total (2a) of the number of moles of ethylene oxide added in the compound (A) represented by a in the general formula (1) to a degree of polysiloxane polymerization (p) represented by p in the general formula (1) is 1.0 or more to 10.0 or less.

5. An ink cartridge comprising an ink and an ink storage portion storing the ink, wherein the ink comprises the aqueous ink according to claim 1.

6. An ink jet recording method of recording an image onto a recording medium by ejecting an ink from a recording head of an ink jet type, wherein the ink comprises the aqueous ink according to claim 1.

7. The ink jet recording method according to claim 6, comprising applying the aqueous ink to be used to record an image of a unit region of the recording medium onto the unit region of the recording medium in a divided amount a plurality of times by using an ink jet recording apparatus including the recording head so as to scan the recording head over the unit region a plurality of times.

8. The ink jet recording method according to claim 6, wherein in the applying the aqueous ink onto the unit region of the recording medium in a divided amount a plurality of times, a time interval between the plurality of scans for recording on the unit region is 1 second or more to 10 seconds or less.

9. The ink jet recording method according to claim 6, wherein the recording medium is a recording medium having a coating layer.
